(19) United States
(12) Patent Application Publication
(10) Pub. No.: US 2016/0301227 A1
(43) Pub. Date: Oct. 13, 2016

(54) LIMITING INRUSH OF CURRENT TO A CAPACITOR BASED ON AN INTERVAL

(71) Applicant: HEWLETT PACKARD ENTERPRISE DEVELOPMENT LP, Houston, TX (US)

(72) Inventors: Daniel Humphrey, Cypress, TX (US); Samantha Jean Castillo, Houston, TX (US); Amin Mohamed Bemat, Cypress, TX (US)

(73) Assignee: HEWLETT PACKARD ENTERPRISE DEVELOPMENT LP, Houston, TX (US)

(21) Appl. No.: 15/037,393

(22) PCT Filed: Dec. 3, 2013
(86) PCT No.: PCT/US2013/072874

§ 371 Date: Jun. 30, 2016

(51) Int. Cl. H02J 7/00

(52) U.S. Cl. CPC H02J 7/0031; H02J 7/0068; H02J 7/345

(57) ABSTRACT

Examples herein disclose determining an interval to limit an inrush of current to charge a capacitor. The interval is based on a peak input voltage without exceeding a current limitation. The examples connect and disconnect a switch to charge the capacitor in accordance with the interval.

### CROSS-REFERENCE TO RELATED APPLICATION

Pursuant to 35 U.S.C. §371, this application is a United States National Stage Application of International Patent Application No. PCT/US2013/072874, filed on Dec. 3, 2013, the contents of which are incorporated by reference as if set forth in their entirety herein.

### BACKGROUND

Inrush current refers to an input current drawn by an electrical device when turned on. The inrush of current may exceed particular current limitations, potentially resulting in failures of the electrical device and other associated electrical components.

### BRIEF DESCRIPTION OF THE DRAWINGS

In the accompanying drawings, like numerals refer to like components or blocks. The following detailed description references the drawings, wherein:

FIG. 1 is a block diagram of an example circuit including a controller to determine an interval to charge a capacitor, the controller uses the interval for connecting and disconnecting the switch to the capacitor;

FIG. 2A is a example data waveform illustrating an interval to limit an inrush of current, the interval includes a turn on point and a turn off point corresponding to an input voltage to charge and discharge a capacitor, respectively;

FIG. 2B is an example timing diagram illustrating an initialization of an input voltage and bias voltage of a controller, the example timing diagram further illustrates a turn on and turn off of an interval to connect and disconnect a switch, accordingly;

FIG. 2C is an example block diagram of a circuit including power source to provide input voltage, a controller to monitor the input voltage for an interval to determine when to connect and disconnect a switch to charge a capacitor;

FIG. 3 is a flowchart of an example method to determine an interval for limiting an inrush of current to a capacitor, the interval based on reaching a peak voltage without exceeding a current limitation for charging a capacitor through a connection of a switch;

FIG. 4 is a flowchart of an example method to receive a bias voltage and monitor an input voltage for determining an interval for charging a capacitor, the interval is readjusted based upon a measurement of voltage across the capacitor;

FIG. 5A is a flowchart of an example method to determine a turn on point for connecting a switch for charging a capacitor;

FIG. 5B is a flowchart of an example method to determine a turn off point for disconnecting a switch for discharging a capacitor; and

FIG. 6 is a block diagram of an example computing device with a processor to execute instructions in a machine-readable storage medium for determining an interval for connecting and disconnecting a switch, thereby limiting an inrush of current to a capacitor.

### DETAILED DESCRIPTION

Inrush current may potentially result in failures of various electrical components, such as blowing fuses and/or breakers. To implement control over the inrush of current, implementations may use various additional dedicated electrical components such as relays, resistors, and other such electrical components which may consume a large amount of real estate.

To address these issues, examples disclose a circuit to limit an inrush of current to a capacitor by managing the inrush of current to the circuit. The circuit determines an interval in which to limit the inrush of current in which a switch is connected thereby allowing the inrush of current to a capacitor. The interval is a window in which to charge the capacitor by connecting and disconnecting the switch, accordingly. Determining the interval, limits the inrush of current to the capacitor ensuring a particular current threshold is not exceeded. Limiting the inrush of current to the capacitor prevents the potential failures of the electrical components within the circuit. Additionally, the examples disclosed herein utilize existing components within the circuit which may occupy less volume within the circuit.

In another example discussed herein, a controller associated with the circuit readjusts the interval based on the voltage across the capacitor. Readjusting the interval, the controller may operate in response to energy storage conditions on the capacitor. For example upon disconnection of the switch, the capacitor may have residual and/or leftover charge. Thus, the interval may be shortened to accommodate the residual charge on the capacitor.

In a further example discussed herein, the interval may be obtained by determining a turn on point and turn off point in which to connect and disconnect the switch, accordingly. The turn on point may be calculated based on the current limitation and impedance associated with the switch. The current limitation represents a threshold amount of current in which the circuit may handle without causing potential hardware failures. The turn on and turn off points correspond to the input voltage, enabling the controller to monitor the input voltage and efficiently track the connection and disconnection of the switch.

In summary, examples disclosed herein limit an inrush of current by connecting and disconnecting a switch in accordance with an interval.

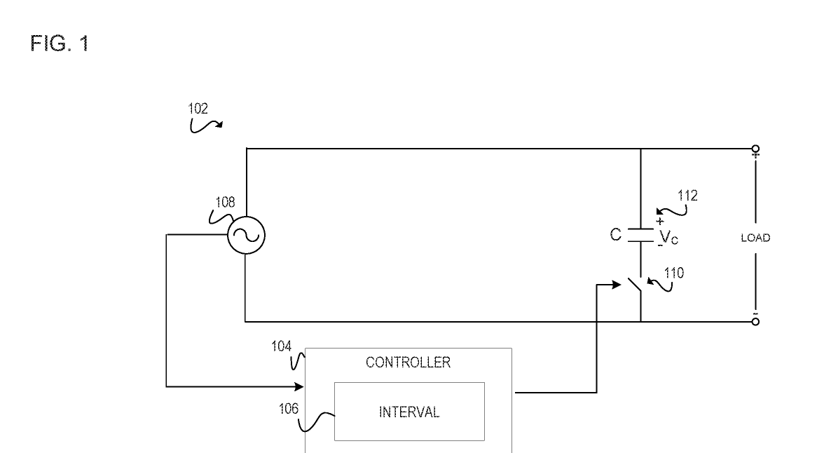

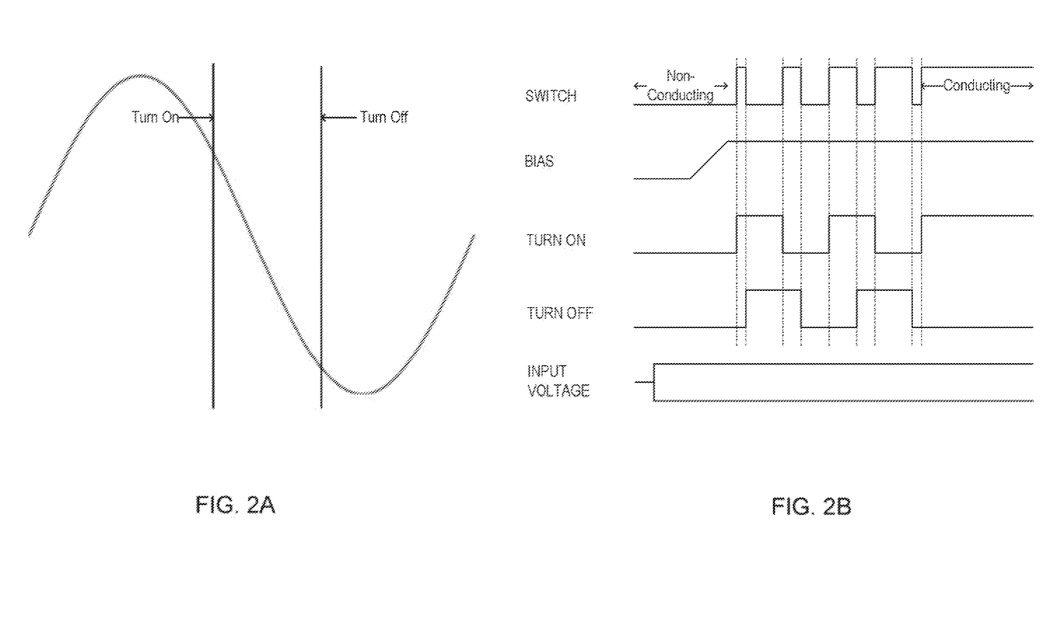

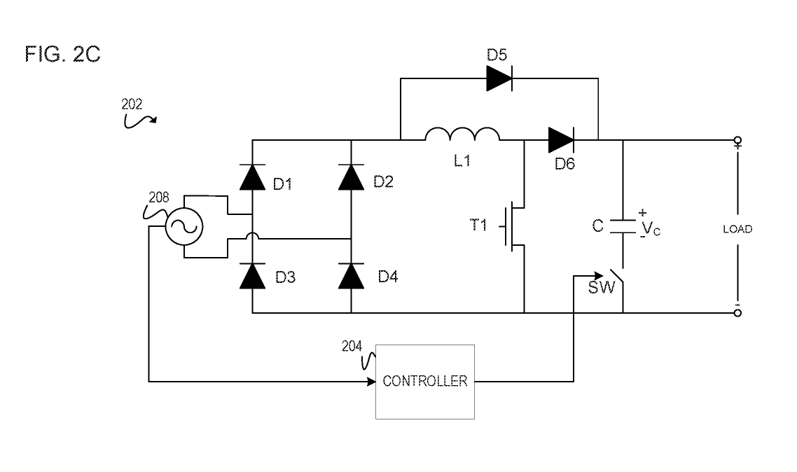

Referring now to the figures, FIG. 1 is a block diagram of an example circuit 102 including a voltage source 108 and a controller 104 to determine an interval 106 in which to connect and disconnect a switch 110 for charging a capacitor 112. The interval is based on a peak voltage as supplied by the voltage source 108 without exceeding a particular current limitation. Connecting and disconnecting the switch 110 according to the interval 106, limits an inrush of current into the capacitor 112. Managing the inrush of current into the capacitor 112, enables the circuit 102 to provide protection to hardware components that may experience failure and/or breakdown at a particular current level. For example, the controller may manage the inrush of current to the capacitor 112 by keeping the current level under a particular threshold. This example manages the inrush of current without blowing fuses, breakers, and other hardware component associated with the circuit 102. The circuit 102 provides power to a load and as such, implementations of the circuit 102 may include a power system, power circuit, embedded system, power supply system, computing system, distributed power system, or other type of circuit system capable of providing power to the load. Further, although FIG. 1 represents the circuit 102 as including hardware components 108, 104, 110, and 112, implementations should not be limited as this was done for illustration purposes. For example, the circuit 102 may include a power factor correcting module. This implementation is illustrated in detail in a FIG. 2C.

The voltage source 108 is a power supply that provides the input voltage to the controller 104. As such, the voltage source 108 provides current to the circuit 102 and as such, implementations of the voltage source 108 includes a power supply, power feed, power source, generator, power circuit, energy storage, power system, or other type of voltage source capable of providing the input voltage to the controller 104 and current to the circuit 102.

The controller 104 manages the inrush of current to the capacitor 112 by determining the interval 106. The interval is a range of time in which the switch is connected to enable the flow of current to the capacitor 112. Implementations of the controller include a processor, circuit logic, a microchip, chipset, electronic circuit, microprocessor, semiconductor, microcontroller, central processing unit (CPU), or other device capable of determining the interval 106 in which to connect and disconnect the switch 110.

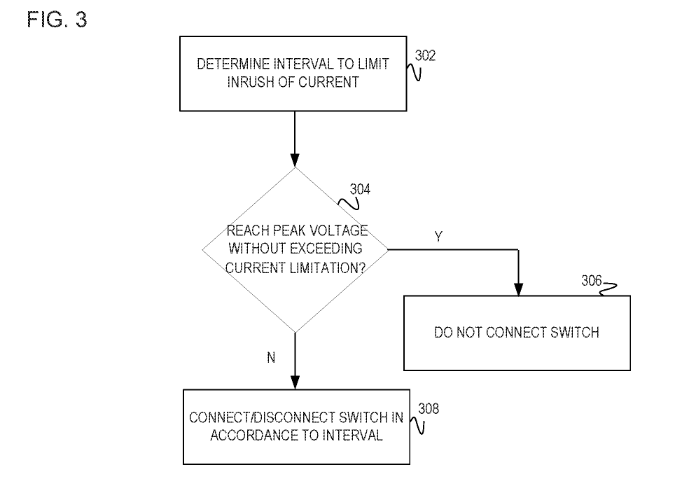

The interval 106 is the time period in which the switch 110 is connected, thereby enabling the capacitor 112 to charge. In one implementation, the interval 106 may include the turn on point to connect the switch 110 and the turn off point in which to disconnect the switch 110. In this implementation, the controller 104 monitors the input voltage from the voltage source 108 to determine when the input voltage reaches the peak voltage without exceeding the current limitation. The controller 104 may then transmit a signal to the switch 110 to connect and/or disconnect, accordingly. In another implementation, the controller 104 may determine the interval 106 by calculating the peak voltage from the input voltage based on the current limitation and an impedance associated with the switch 110. This implementation is described in detail in FIGS. 3-5B.

The switch 110 provides the flow of current to the capacitor 112 upon the connection. As such, the switch 110 interrupts the flow of current from the voltage source 108 to the capacitor upon the disconnection. The connection and the disconnection 110 are provided according to the interval 106. Implementations of the switch 110 include an electromechanical device, electrical device, switching voltage regulator, transistor, relay, logic gate, binary state logic, or other type of electrical device that may interrupt the flow to the capacitor 112.

The capacitor 112 is a hardware component used to store energy (e.g., current) electrostatically in an electrical field. In one implementation, the capacitor 112 may block direct current from the voltage source 108, while allowing alternating current to pass, thereby providing power to the load.

FIG. 2A is a example data waveform illustrating an interval to limit an inrush of current, the interval includes a turn on point and a turn off point to charge and discharge a capacitor, respectively. The interval is based on a cycle of input voltage to a circuit as in FIG. 2C. The input voltage follows a waveform in which the flow of current periodically reverses in direction as illustrated when the waveform decreases. As illustrated in FIG. 2A, the turn on point is the peak voltage of the input voltage without exceeding a current limitation to connect the switch to the capacitor, thereby allowing the inrush of current to charge the capacitor. The turn off point disconnects the switch from the capacitor, thereby preventing the inrush of current from charging the capacitor. The interval is a window of time based on the input voltage in which the capacitor is charged with the inrush of current. In one implementation, a controller may determine the turn on point when the input voltage decreases in time. In this implementation, the turn off point may be determined prior to voltage reaching a negative threshold. The timing diagrams of the input voltage, the turn on point, the turn off point, a bias voltage received by the controller, and the switch is illustrated in FIG. 2B.

FIG. 2B is an example timing diagram illustrating an initialization of an input voltage and bias voltage of a controller. The example timing diagram further illustrates the initialization of a turn on point and turn off point in the interval based on an input voltage as in FIG. 2B. The turn on point and the turn off point are considered a voltage point in the input voltage of when to connect and disconnect a switch. Controlling the connection and disconnection of the switch, the controller manages an inrush of current to charge the capacitor. As illustrated in FIG. 2B, a voltage source delivers the input voltage from which the controller receives the bias voltage. The bias voltage ramps up after a time period after the voltage source delivers the input voltage. The time period between the input voltage to the bias voltage is due to current flowing to the circuit prior to reaching the controller. The controller may then determine the turn on point in which to connect the switch for conducting at time intervals. The conduction of the switch represents the time interval in which the switch is connected, thereby enabling the flow of current to charge the capacitor. The controller may then determine the turn off time initializes the non-conducting interval of the switch.

FIG. 2C is a block diagram of an example circuit 202 including a voltage source 208 to provide input voltage, a controller 204 to monitor the input voltage. The controller 204 determines an interval in which to connect and disconnect a switch (SW) to charge a capacitor (C). The circuit 202 represents hardware components for producing the input voltage with the interval in FIG. 2A and the timing diagram in FIG. 2B. The circuit 202, the voltage source 208, and the controller 204 may be similar in structure and functionality to the circuit 102, the voltage source 108, and thecontroller 104 as in FIG. 1. The circuit 202 includes a power factor correcting module component to correct a nonlinearity of a load. The power factor correcting module includes diodes (D1-D6), inductor (L1), and transistor (T1) which may change the wave form of the load to improve a power factor.

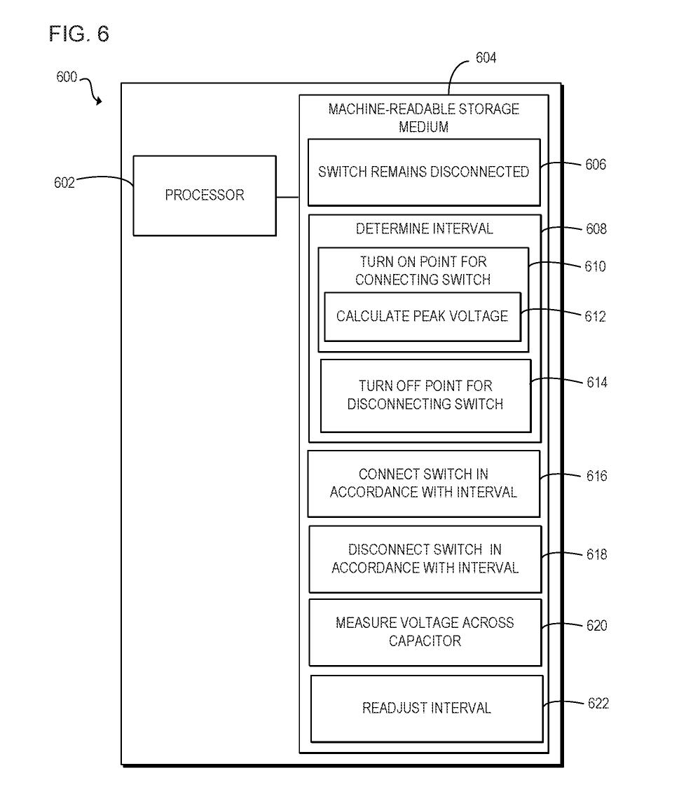

FIG. 3 is a flowchart of an example method to determine an interval for limiting an inrush of current to a capacitor. The interval is based on a peak input voltage without exceeding a current limitation for charging a capacitor through a connection and disconnection of a switch. The interval may include points across the input voltage in which a switch may be connected and disconnected to charge the capacitor. Disconnecting the switch, prevents the capacitor from exceeding the current limitation. The current limitation may include a threshold in which the current may damage hardware components upon exceeding the current limitation. Thus disconnecting the switch, the controller may prevent damage to the hardware components within the circuit. Additionally, determining the interval to connect and disconnect the switch provides an inrush control of the current to the capacitor while occupying less volume as the circuit may be without components dedicated to controlling the inrush of current. In discussing FIG. 3, references may be made to the components in FIGS. 1-2C to provide contextual examples. For example, a controller 104 as in FIG. 1 executes operations 302-308 to connect and disconnect the switch in accordance with an interval. Additionally, although FIG. 3 is described as implemented by the controller 104 as in FIG. 1, it may be executed on other suitable components. For example, FIG. 3 may be implemented in the form of executable instructions on a machine-readable storage medium 604 as in FIG. 6.

At operation 302, the controller may determine the interval to limit the inrush of current to the capacitor. The interval is a window of time in which the switch remains connected, thus allowing current to reach the capacitor. The interval may be based on characteristics of the switch (e.g., impedance), measurement limitations of sensors within the controller, and/or the peak potential (e.g., peak voltage and frequency) of the input voltage. The interval includes the turn on point in which to connect the switch to allow current to flow to the capacitor and the turn off point in which the switch is disconnected to prevent current flowing to the capacitor. In operation 302, the circuit which includes the capacitor and controller may receive an input voltage from a voltage source. Upon receiving the input voltage, the controller may receive a bias voltage for the functioning of the controller. Additionally in operation 302, the controller may sync a clock with the input voltage to determine when the input voltage has reached the peak voltage without exceeding the current limitation. These implementations are described in detail in later figures.

At operation 304, the controller determines whether the input voltage has reached the peak voltage without exceeding the current limitation. In one implementation, the controller may monitor the input voltage to determine a magnitude of voltage of the input voltage. Using the magnitude of voltage and a predetermined resistance, the controller may calculate the magnitude of current at the particular magnitude of voltage. This enables the controller to determine when the input voltage is exceeding a particular current level, thus preventing the connection of the switch to charge the capacitor and thereby protecting the hardware components of the circuit. Upon determining the peak voltage has exceeded the current limitation, the controller may not connect the switch as at operation 306. Upon determining the peak voltage has not exceeded the current limitation, the controller may connect and disconnect the switch in accordance to the interval as at operation 308.

At operation 306 upon determining the peak voltage has exceeded the current limitation at operation 304, the controller may not connect the switch to the capacitor. In this implementation, the switch remains disconnected, thus the disconnection of the switch continues to prevent current from reaching the capacitor. This prevents the inrush of current from reaching the capacitor and may mitigate damage from the inrush of current that exceeds the current limitation.

At operation 308, the controller may connect and disconnect the switch in accordance with the interval determined at operation 302. The interval includes the turn on point in which to connect the switch and the turn off point which disconnects the switch. In another implementation of operation 308, prior to connecting the switch, the switch may remain disconnected. In this implementation, until connecting the switch at operation 308, the capacitor may not be charging, thereby preventing the inrush of current to the capacitor.

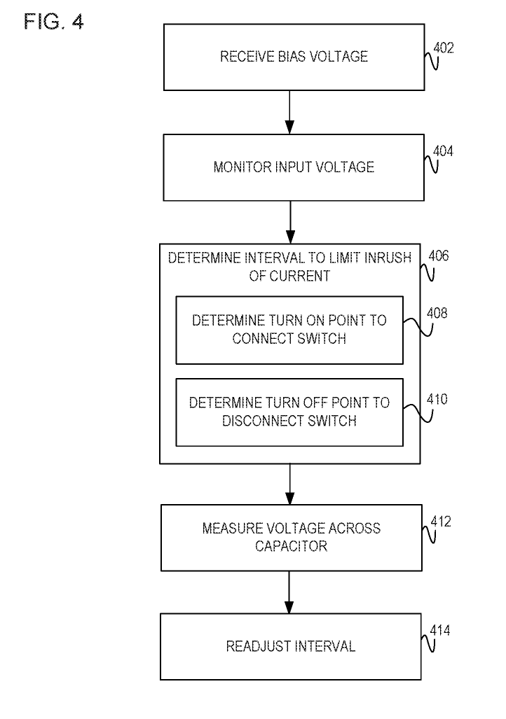

FIG. 4 is a flowchart of an example method to receive a bias voltage and monitor an input voltage for determining an interval for charging a capacitor, the interval is readjusted based upon a measurement of voltage across the capacitor. Readjusting the interval, the method may operate in response to energy storage conditions on the capacitor. For example after an initial interval, the capacitor may have an initial charge left, thus the method may readjust the next interval based on the leftover charge on the capacitor to manage the inrush of current on the capacitor. In discussing FIG. 4, references may be made to the components in FIGS. 1-2C to provide contextual examples. For example, a controller 104 as in FIG. 1 executes operations 402-414 to determine an interval for connecting and disconnecting the switch in accordance with the interval. Additionally, although FIG. 4 is described as implemented by the controller 104 as in FIG. 1, it may be executed on other suitable components. For example, FIG. 4 may be implemented in the form of executable instructions on a machine-readable storage medium 604 as in FIG. 6.

At operation 402, the controller receives the bias voltage in which powers the controller. In this implementation, a voltage source provides input voltage to the circuit, while the controller receives the bias voltage from the input voltage. Receiving the bias voltage, powers on the controller and signals to the controller to determine the interval to limit the inrush of current to the capacitor.

At operation 404, the controller monitors the input voltage from the voltage source. In this implementation, the controller may sync an internal clock with the input voltage to determine when the input voltage has reached a turn on point. The controller may use a sensor to monitor the input voltage. In this operation, the controller may monitor a frequency of the input voltage to determine a cycle of the input voltage. Monitoring the cycle of the input voltage, the controller may determine when the input cycle reaches the turn on point of the interval as at operation 406.

At operation 406, the controller determines the interval in which to connect and disconnect the switch for limiting the inrush of current to the capacitor. In one implementation, upon determining the interval to limit the inrush of current to the circuit at operation 406, the controller may proceed to connecting the switch in accordance with the interval. For example upon determining the interval at operation 406, the controller may proceed to operation 308 as in FIG. 3 to connect the switch to the capacitor, thereby enabling current to flow into the capacitor. Operation 406 may be similar in functionality to operation 302 as in FIG. 3.

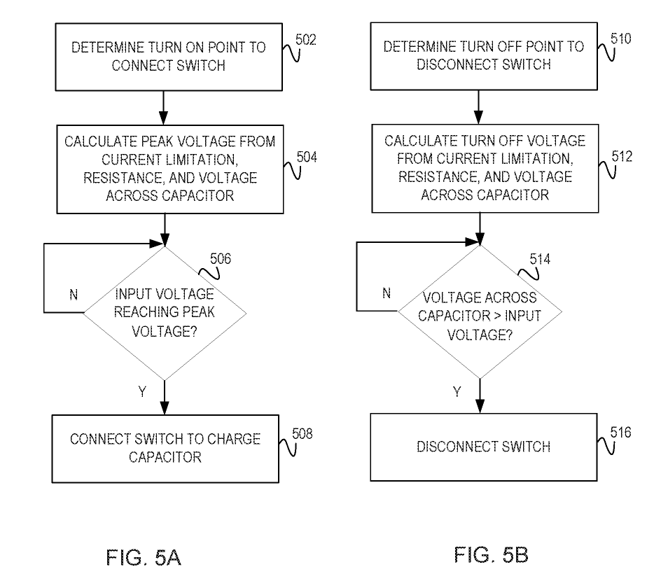

At operation 408, the controller determines the turn on point to connect the switch to the capacitor. The turn on point is considered a peak voltage point on the input voltage without exceeding a particular current limitation. In one implementation, the turn on point is the peak voltage point when the input voltage may be decreasing in a cycle as in FIG. 2A. In another implementation, the turn on point is calculated based on the current limitation and impedance associated with the switch. This implementation may be explained in further detail in FIG. 5A.

At operation 410, the controller determines the turn off point in which to disconnect the switch to the capacitor. In one implementation, the turn off point is calculated based on the current limitation, impedance, and voltage across the capacitor. In another implementation, the turn off point is considered the point on the input voltage when the voltage across the capacitor is greater than the input voltage. This implementation may be explained in further detail in FIG. 5B.

At operation 412, the controller measures the voltage across the capacitor. In one implementation, the voltage across the capacitor is used to determine the turn off point as at operation 410. In this implementation, if the voltage across the capacitor is greater than the input voltage, the controller disconnects the switch from the capacitor to prevent the capacitor from exceeding the current limitation. In another implementation, the voltage across the capacitor is used to readjust the interval as operation 406. In this implementation, the interval is readjusted to obtain a next interval based on the voltage across the capacitor.

At operation 414, the controller readjusts the interval based on the voltage measured across the capacitor at operation 410. Readjusting the interval, the controller may operate in response to charging conditions.

FIGS. 5A-5B represent an illustration of an example method to determine an interval to connect and disconnect a switch, thereby limiting an inrush of current to a capacitor. The interval includes determining a turn on point to connect the switch for charging the battery as in FIG. 5A. The interval also includes determining a turn off point for disconnecting the switch as in FIG. 5B. In discussing FIGS. 5A-5B, references may be made to the components in FIGS. 1-2C to provide contextual examples. For example, a controller 104 as in FIG. 1 executes operations 502-516 to determine a turn on point and turn off point of the interval for connecting and disconnecting, accordingly. Additionally, although FIGS. 5A-5B are described as implemented by the controller 104 as in FIG. 1, it may be executed on other suitable components. For example, FIG. 5A and/or FIG. 5B may be implemented in the form of executable instructions on a machine-readable storage medium 604 as in FIG. 6.

FIG. 5A is a flowchart of example method to determine a turn on point for connecting a switch for charging a capacitor. The turn on point is a beginning of an interval in which the switch is to connect to the capacitor, thereby allowing current to flow to the capacitor for charging the capacitor.

At operation 502, the controller determines the turn on point on the interval in which the controller signals to the switch to connect to the capacitor. The turn on point is calculated from the input voltage without exceeding a current limitation. The current limitation represents a threshold of current to the capacitor is a threshold amount of current in which the circuit may handle without causing potential hardware failures. For example, the current limitation may be around 30 amps prior to blowing fuses and/or breakers within the circuit. In one implementation, the controller calculates the turn on point of the input voltage at operation 504.

At operation 504, the controller calculates the turn on point based on the input voltage without exceeding the current limitation. The turn on point is the peak voltage of the input voltage without exceeding the current limitation. For example in one implementation, the turn on point is calculated from the current limitation and resistance associated with the switch, such as in Equation 1. In another implementation, the turn on point is calculated from the current limitation, resistance associated with the switch and the voltage across the capacitor as in Equation 2. The resistance is the impedance of the circuit from the switch to the capacitor and as such, may be pre-defined or measured from the controller. As explained earlier, the current limitation (I_{LIMIT}) is considered a threshold limit on an amount of current that may be predefined according to a rating of a hardware component and/or measured by the controller. The current limitation is the amount of current the circuit may handle prior to breakdown of the hardware components. For example, assume the current limitation is around 30 amps, the input voltage may vary in accordance to the resistance associated with the switch and the voltage across the capacitor; however, the current limitation remains constant even though intervals may be adjusted based on the voltage across the capacitor (V_{CAPACITOR}).

V_{TURN ON}=I_{LIMIT}R Equation (1)

V_{TURN ON}=I_{LIMIT}R+V_{CAPACITOR} Equation (2)

At operation 506, the controller determines whether the input voltage has reached the turn on point. The controller monitors the input voltage to determine when the input voltage reaches the turn on point. The turn on point is calculated at operation 504 as the peak voltage based on the resistance and current limitation. In one implementation, if the input voltage has not yet reached the turn on point, the controller may continue monitoring at operation 506 for the turn on point. In this implementation, if the input voltage has not yet reached the turn on point, the switch remains disconnected as at operation 306 as in FIG. 3. In another implementation, if the input voltage has reached the turn on point, the controller may proceed to operation 508 to connect the switch for charging the capacitor. In a further implementation of operation 506, the controller may monitor when the input voltage is decreasing, signaling to the controller that the input voltage is closely reaching the turn on point.

At operation 508, the controller transmits a signal to the switch to connect to the capacitor. The signal indicates to the switch to close, thus enabling current to flow through the switch to the capacitor. In one implementation, once connecting the switch based on the beginning interval, the controller monitors to determine when to transmit the signal to the switch for disconnection. This implementation is discussed in detail in FIG. 5B. Operation 508 may be similar in functionality to operation 308 as in FIG. 3.

FIG. 5B is a flowchart of an example method to determine a turn off point for disconnecting a switch. The disconnection of the switch prevents the capacitor from exceeding a current limitation, thereby limiting an inrush of current. The turn off point represents a voltage point on the interval in which the switch is disconnected. Disconnecting the switch, the controller may interrupt the flow of current to the capacitor and thereby manage the inrush of current.

At operation 510, the controller determines the turn off point to disconnect the switch. In another implementation, the turn off point is calculated from Equation 2 at operation 512.

At operation 512, the controller calculates the turn off point from the input voltage. The turn off point is a point on the input voltage calculated based on the current limitation, resistance associated with the switch, and the voltage across the capacitor. In one implementation, by using Equation 2, the controller calculates when the voltage across the capacitor is greater than the peak voltage calculated at operation 504. If the voltage across the capacitor is greater than the peak voltage calculated at operation 504, this signals to the controller to disconnect the switch.

At operation 514, the controller monitors the input voltage and the voltage across the capacitor. If the input voltage is less than the voltage across the capacitor, the controller proceeds to operation 516 to disconnect the switch. In other words, if the voltage across the capacitor is larger than the input voltage, the controller proceeds to operation 516. If the voltage across the capacitor is smaller than the input voltage, the controller may continue monitoring the input voltage and/or the voltage across the capacitor at operation 514.

At operation 516, the controller transmits a signal to the switch to disconnect, preventing the inrush of current from reaching the capacitor. In this implementation, there may be a voltage potential left across the capacitor until the capacitor bleeds down. This voltage potential is taken into account when the controller determines a next interval. This enables interval to be adjusted based on the voltage potential across the capacitor.

FIG. 6 is a block diagram of an example computing device 600 with a processor 602 to execute instructions 606-622 in a machine-readable storage medium 604. Specifically, the computing device 600 with the processor 602 is to determine an interval in which to connect and disconnect a switch, thereby limiting an inrush of current to a capacitor. Although the computing device 600 includes processor 602 and machine-readable storage medium 604, it may also include other components that would be suitable to one skilled in the art. For example, the computing device 600 may include the controller 104 as in FIG. 1. The computing device 600 is an electronic device with the processor 602 capable of executing instructions 606-622, and as such embodiments of the computing device 600 include a computing device, mobile device, client device, personal computer, desktop computer, laptop, tablet, video game console, or other type of electronic device capable of executing instructions 606-622. The instructions 606-622 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory).

The processor 602 may fetch, decode, and execute instructions 606-622 to limit the inrush of current to the capacitor by determining an interval in which to connect and disconnect a switch. In one implementation, once executing instructions 606-608, the processor 602 may proceed to execute instructions 612-614. In another implementation, once executing instructions 606-614, the processor 602 may proceed to execute instructions 616-618 to connect and disconnect the switch in accordance with the interval. In a further implementation, once executing instructions 606-618, the processor 602 may execute instructions 620-622 for readjusting the interval from voltage across the capacitor. Specifically, the processor 602 executes instructions 606-608 to: continue a disconnection of the switch; and determining an interval for the switch to connect and disconnect. The processor 602 may proceed to instructions 610-614 to: determine a turn on point for connecting the switch, the turn on point is based on a peak voltage of an input voltage which does not exceed a current limitation; and determine a turn off point for disconnecting the switch, the disconnection limits current from continuing to charge the capacitor. The processor 602 may then execute instructions 616-618 to: connect the switch upon reaching the turn on point of the interval; and disconnecting the switch upon reaching the turn off point of the interval. Further, the processor 602 may execute instructions 620-622 to: measure the voltage across the capacitor; and then readjusting the interval which was determined at instructions 608. In this implementation, the processor 602 may determine the next interval based upon the voltage across the capacitor.

The machine-readable storage medium 604 includes instructions 606-622 for the processor 602 to fetch, decode, and execute. In another embodiment, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 604 may include an application and/or firmware which can be utilized independently and/or in conjunction with the processor 602 to fetch, decode, and/or execute instructions of the machine-readable storage medium 604. The application and/or firmware may be stored on the machine-readable storage medium 604 and/or stored on another location of the computing device 600.

In summary, examples disclosed herein limit an inrush of current by connecting and disconnecting a switch in accordance with an interval.

We claim:

1. A circuit to limit an inrush of current to a capacitor, the circuit comprising:
a controller to:
determine a interval for limiting the inrush of current to charge the capacitor, the interval based on a peak input voltage without exceeding a current limitation; and
a switch to connect and disconnect for charging the capacitor in accordance with the interval.

2. The circuit of claim 1 comprising:
the capacitor to charge when the switch is connected; and
a source to supply input voltage to the circuit;
wherein the controller is to monitor the input voltage to determine when the input voltage reaches the peak input voltage without exceeding the current limitation.

3. The circuit of claim 1 wherein to determine the interval for limiting the inrush of current to charge the capacitor, the controller is to:
determine when an input voltage reaches the peak input voltage for connecting the switch, the peak input voltage based on a resistance associated with the switch, the current limitation, and a voltage across the capacitor; and
determine when the input voltage is less than the voltage across the capacitor for disconnecting the switch.

4. The circuit of claim 1 wherein the controller is to:
disconnect the switch in accordance with the interval, the switch disconnection based when voltage across the capacitor is greater than an input voltage, wherein the interval limits an inrush of current to the capacitor.

5. The circuit of claim 1 wherein the controller is to:
measure the voltage across the capacitor; and
readjust the interval based on the voltage across the capacitor.

6. The circuit of claim 1 wherein the switch remains disconnected until reaching the interval.

7. The circuit of claim 1 wherein the controller is to:
receive a bias voltage to determine the interval to limit the inrush of current; and
monitor the input voltage to determine when the input voltage has reached the peak input voltage without exceeding the current limitation.

8. The circuit of claim 1 wherein, to determine the interval, the controller is to determine a turn on point for connecting the switch and a turn off point for disconnecting the switch.

9. A non-transitory machine-readable storage medium comprising instructions that when executed by a processor cause the processor to:
connect a switch for charging a capacitor in accordance with an interval, the switch connection based on a peak voltage without exceeding a current limitation; and
disconnect the switch in accordance with the interval, the switch disconnection based when voltage across the capacitor is greater than an input voltage, wherein the interval limits an inrush of current to the capacitor.

10. The non-transitory machine-readable storage medium including the instructions of claim 9 comprising instructions that when executed by the processor cause the processor to:
measure the voltage across the capacitor; and
readjust the interval based on the voltage across the capacitor.

11. The non-transitory machine-readable storage medium including the instructions of claim 9, wherein the switch remains disconnected until reaching the interval.

12. The non-transitory machine-readable storage medium including the instructions of claim 9 comprising instructions that when executed by the processor cause the processor to:
receive a bias voltage; and
monitor the input voltage to determine when to connect the switch for charging the capacitor at the interval.

13. The non-transitory machine-readable storage medium including the instructions of claim 9 comprising instruction that when executed by the processor cause the processor to:
determine the interval including a turn on point for connecting the switch and a turn off point for disconnecting the switch.

14. The non-transitory machine-readable storage medium including the instructions of claim 9, wherein to connect the switch for charging the capacitor in accordance with the interval, the switch connected based on the peak voltage without exceeding the current limitation comprises instructions that when executed by the processor cause the processor to:
calculate the peak voltage based on resistance associated with the switch, the current limitation, and the voltage across the capacitor.

15. A method, executed by a controller, the method comprising:
determining an interval to limit an inrush of current to charge a capacitor, the interval based on a peak input voltage without exceeding a current limitation; and
connecting and disconnecting a switch to charge the capacitor in accordance with the interval.

16. The method of claim 15 wherein determining the interval comprises:
determining a turn on point to connect the switch to charge the capacitor the turn on point is the peak voltage of an input voltage and is calculated by an impedance associated with the switch and the current limitation;
determining a turn off point to disconnect the switch to prevent the capacitor from exceeding the current limitation , the turn off point is when the input voltage is less than voltage across the capacitor.

17. The method of claim 15 comprising:
receiving a bias voltage to determine the interval to limit the inrush of current; and
monitoring input voltage to determine when the input voltage has reached the peak input voltage without exceeding the current limitation.

18. The method of claim 15 comprising:
syncing internal clock of a controller with an input voltage to monitor the input voltage; and
connecting the switch when an input voltage is decreasing.

19. The method of claim 15 wherein the switch remains disconnected without charging the capacitor until reaching the interval.

20. The method of claim 15 comprising:
measuring voltage across the capacitor; and
readjusting the interval based on the voltage across the capacitor.
